(19) United States
(12) Patent Application Publication
(10) Pub. No.: US 2004/0024674 A1
(43) Pub. Date: Feb. 5, 2004

(54) Method for enterprise valuation

(76) Inventor: Stanley J. Feldman, Ipswich, MA (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/210,752

(22) Filed: Jul. 31, 2002

(51) Int. Cl. G06F 17/60

(52) U.S. Cl. 705/36

(57) ABSTRACT

A system and method for valuing a business enterprise and generating valuation reports in real-time by extracting financial data representing the enterprise from standardized, assured sources, generating financial values representing financial aspects of the enterprise from the extracted input data and from financial values generated by numerous models, determining present and expected values of the enterprise as functions of present and expected profits and costs of the enterprise, and generating a control premium value, and possibly a liquidity discount representing the marketability of ownership.

### FIELD OF THE INVENTION

The present invention relates to a method and interactive system for determining the unique value of a business enterprise, or firm in real time. Firms or enterprises to be valued can be public or private entities, although the invention is particularly well suited to disentangle the financial disclosures of private firms, is required in order to objectively determine their value. The data and information required by the method are-standardized, defined and regulated independently of the judgements of the interested parties. All data and information generated by the invention and gathered from the user of the invention-are evaluated and a set of valuation factors are derived. All of these processes take place in real time and are delivered to the end—user as a set of customized graphs, charts and written analysis via the Internet platform in the presently preferred embodiment.

### BACKGROUND OF THE INVENTION

The acquisition or sale of whole or partial interests in business enterprises, the planning for such an acquisition, sale or posthumous transfer of business enterprises, or disputes pertaining to interests in such enterprises are very common occurrences in business and in the financial and investment industries in general. A recurring problem is such activities, however, is in determining the value of such enterprises, such as firms or companies or divisions or other partial interests in such enterprises.

One problem, for example, may be in that it is often difficult to determine what business or financial elements or relationships actually comprise a given enterprise in the current business and financial environment. For example, current business, economic and financial models often involve partial, overlapping, inter-related, non-traditional or unconventional ownership structures. Accordingly, complex business, financial and economic relationships arise, the complexity of which are often significantly increased by the global nature of many enterprises and business relationships or structures. The complexity and difficulty of determining the value of an enterprise is also often increased by the existence of unconventional, non-traditional, confidential, or variable or vaguely defined employment, compensation or other financial arrangements between an enterprise and its owners, owners' family members, employees, officers or shareholders or between the enterprise and other enterprises.

The difficulty in valuing an enterprise is made still more difficult because different valuators often use different business or economic factors or elements and different economic, financial or accounting theories, principles, practices and models in valuing an enterprise. For example, different valuators may differ significantly upon whether a given financial or business factor or element is significant, on how the factor or element should be weighted, and on the manner in which the factor or element is used in valuing the enterprise. This problem is compounded still further many of the factors in valuing an enterprise are matters of judgement or opinion, and may differ significantly, and in that in many instances the valuators may use “standard” or industry “normalized” or “rule-of-thumb” values, which may have a poor relationship to the specific instance or may actually be in error in the specific circumstances. This is particularly a problem when the firm's expected future earnings need to be calculated and past historical analysis provides little or no guide as to how to best evaluate the risks and opportunities associated with such expectations. Often, selection of the industry the firm is in provides is weighted heavily in a given valuation, without consideration of the fact that firms within a particular sub-segment of an industry may have very wide and divergent growth paths. Selecting among these paths is complex and often beyond the scope and expertise of those entrusted with valuing the firm or enterprise under consideration.

Lastly, and in part due to the above discussed problems, the valuation of an enterprise is often a difficult task simply because of the complexity of the task, so that the valuation process is often and very prone to error. All of these factors in their totality, in fact, inhibit cross-checking for errors, reviews of the valuation, or repeated trials using different factors or weights to validate a valuation. However, many financial and business valuation systems of the prior art address some of these problems discussed above by implementing parts of the valuation process using various spreadsheet models that generally run on local computers and function as calculators rather than systems and methods that incorporate data, analytical models and report-writing systems designed to develop customized, independent and objective results.

While such computer based systems address some of the problems of complexity and time and permit error checking and cross review of the valuations and the reiteration of valuations using different factors, weights and methods, the computer based systems of the prior art are essentially implementations of the traditional methods and processes of the prior art. That is, the computer based systems of the prior art, by implementing traditional methods and processes, also implement and incorporate all of the problems of the prior art that have been discussed above, such as differences in the accuracy of the data used in an valuation, the method used for the valuation, and the judgement and opinion based decisions made by the valuator during a valuation.

Moreover, the majority of computer-based enterprise valuation systems focus only on the quantitative valuation analysis and leave the valuator to research for the appropriate valuation data. This valuator-dependent research element can result in a highly inaccurate valuation due to the many problems discussed above, such as valuator prejudice, lack of industry knowledge or simple research error. Given the quantitative focus of these computer-based enterprise valuation systems, the valuator is also forced to write the ultimate valuation reports and conclusions, which can also lead to additional error and lack of clarity in the valuation of enterprises.

It must also be noted that the majority of computer-based enterprise valuation systems of the prior art address only the valuation of specific models of enterprises, for example, large publicly owned or traded corporations and businesses, largely because large, publicly held corporations are of more interest to a greater number of parties. As a consequence, there has been significantly more research and study invested with respect to large, publicly held enterprises, so that the financial and Valuation models are more highly developed, the factors are better known, and there is significantly more information available in general for the valuation of large enterprises. Moreover, much of the analysis that has arisen out of this focus on publicly held enterprises is applied to smaller privately-held enterprises by these computer-based enterprise valuation systems. This application is often in error as the characteristics of publicly held firms are generally very different in material respects, such as revenues, locations, capital structure, employees, than smaller, privately held enterprises.

It must also be noted that the majority of computer based enterprise valuation systems of the prior art address only the valuation of specific models of enterprises, and in particular those for relatively large publically owned or traded corporations and businesses, largely because large, publically held corporations are of more interest to a greater number of parties. As a consequence, there has been significantly more research and study invested with respect to large, publically held enterprises, so that the financial and valuation models are more highly developed, the factors are better known, and there is significantly more information available in general for the valuation of large enterprises.

As a consequence, the computer based valuation systems of the prior art rarely accurately address the complete valuation process of smaller and privately controlled businesses and firms, in part due to the cost and time required by the systems to perform a complete valuation, including comprehensive research and a written report, and the resulting low per valuation profit obtainable from such valuations. As a result, the computer based valuation systems of the prior art that address small or privately controlled enterprises are highly dependent on the relative skills and the methodological and research prejudices of the valuator and tend to treat smaller or privately controlled enterprises merely as smaller versions of the large, publicly held enterprises. The result is that the valuations of smaller and privately controlled enterprises are often inaccurate or cannot provide an adequate level of confidence in the correctness of the result.

The present invention addresses and provides solutions for these and other related problems of the prior art.

### SUMMARY OF THE INVENTION

The present invention is directed to a system and method for valuating a publicly or privately held business enterprise, the system including an input data parser, a plurality of models for generating financial values representing an enterprise, a report generator for generating from the financial values at least one valuation output representing a value of the enterprise, and a valuation engine for directing operations of the valuation system.

According to the present invention, the method for valuating a business enterprise includes the steps of extracting financial data representing the enterprise from standard federal tax return information, generating financial values representing the financial aspects of the enterprise from the extracted input data and from the financial values generated by the models, determining an enterprise officer's compensation as an expense of the enterprise, determining present and expected values of the enterprise as functions of present and expected profits and costs of the enterprise, and generating a control premium value wherein a control premium value represents an increase over a market value of a minority interest in the enterprise represented by ownership of the enterprise. The method then concludes with the generation of at least one valuation output representing a value of the enterprise.

The step of extracting data representing the enterprise may further include presenting questions pertaining to the enterprise to a user and extracting data pertaining to the enterprise from answers to the questions.

The method of the present invention may also include a step of generating a liquidity discount value representing a decrease in an ownership value of the enterprise due to an increased risk in selling an enterprise if the enterprise being valued is a privately owned enterprise.

The method of the present invention will further include the steps of separately determining operating and non-operating incomes of the enterprise, determining present and expected values of the enterprise as functions of present and expected profits and costs of the enterprise further comprises, and of determining an enterprise tax shield value that is independent of a method by which the enterprise assets are financed.

The step of determining present and expected values of the enterprise as functions of present and expected profits and costs of the enterprise may further include the steps of determining an expected growth in operating profits of the enterprise, determining enterprise cash flow over a competitive advantage period, and determining an average cost of capital for the enterprise over a period of competitive advantage.

### BRIEF DESCRIPTION OF THE DRAWINGS

The invention will now be described, by way of example, with reference to the accompanying drawings in which:

FIG. 1 is a block diagram of a valuation system;

FIG. 2 is a block diagram of a system in which a valuation system may be implemented;

FIG. 3 is an illustration of a system risk model;

FIG. 4 is an illustration of a systemic risk rating model;

FIG. 5 is an illustration of a cost of capital model;

FIG. 6 is an illustration of a model for determining a value of an enterprise;

FIG. 7 is an illustration of examples of typical liquidity discount values;

FIGS. 8 and 9 are illustrations of CEO wage models;

FIG. 10 illustrates the effects of median control values on the value of an enterprise over time;

FIGS. 11 and 12 are illustrations of models for determining control premiums;

FIGS. 13 and 14 are examples illustrating cost of capital;

FIG. 15 is an illustration relating to the growth of an enterprise; and,

FIG. 16 is an illustration of an industry revenue model.

### DESCRIPTION OF THE PREFERRED EMBODIMENT(S)

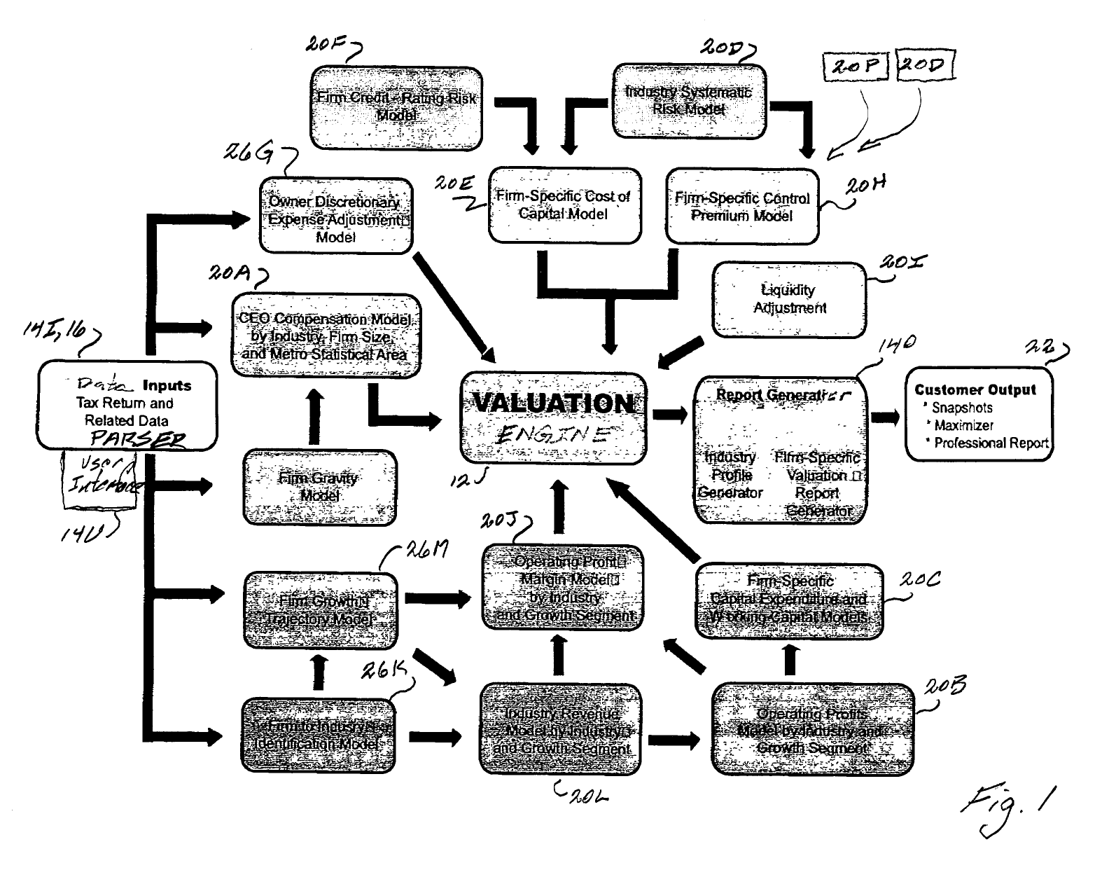

A. Overall Description of an Valuation System 10 (FIG. 1)

Referring to FIG. 1, therein is illustrated a Valuation System 10 in which the present invention may be implemented. As shown therein, an Valuation System 10 will include an Valuation Engine 12 with an associated Input Data Parser 14I and Report Generator 14O that performs the valuation processes of the present invention on Enterprise Input Data 16 pertaining to an Enterprise 18V whose value is to be determined, wherein Enterprise 18V is a member of a set or class of Enterprises 18 of the type or types that may be valuated by the Valuation System 10.

As illustrated, an Valuation Engine 12 employs a number of Valuation Models 20, hereafter referred to as “Models 20”, in the valuation of an Enterprise 18V, specific ones of which are designated by reference numbers 20A, 20B, . . . 20n in the following discussion. As described in further detail in the following discussions, a Model 20 represents a factor, aspect, variable, value or consideration in the valuation of an Enterprise 18 or a factor, aspect, variable, value or consideration used in valuating an Enterprise 20. As will also be discussed, each Model 20 may include one or more Processes 20pa . . . 20pn, generally referred to as Processes 20p, which are typically programs, routines or program modules directing a process or one or more operations.

Each Process 20p defines a process or sequence of method steps for determining a value, factor or on pertaining to the valuation of an Enterprise 18 or some aspect of the valuation of an Enterprise 18 in terms of other such values. Models 20 may also contain Data 20da . . . 20dn, generally referred to as Data 20d, in various forms and formats and representing or pertaining to a specific class, type or set of related financial and economic or business aspects, factors or elements of one or more Enterprises 18, and which is used in determining a variable or factor or so on represented by the model.

For example, and as discussed in detail in the following descriptions, one of the Models 20 employed in the Valuation System 10 implements the methods and data for determining a “control premium” for an Enterprise 18V being valuated. A “control premium”, however, is determined by or is a function of several other factors, including, for example, the “credit risk”, the “cost of capital”, and the “industry system risk” relevant to the Enterprise 18V. The “control premium” Model 20 therefore receives inputs from a “credit risk” Model 20, a “cost of capital” Model 20, and an “industry system risk” Model 20. The Valuation Engine 12 receives a “control premium” input from the “control premium” Model 20 for use in other processes executed by the Valuation Engine 12 in determining the value of the Enterprise 18V, among which are adjusting or modifying the value of the Enterprise 18V by a “liquidity discount” input from a “liquidity discount” Model 20.

In summary, therefore, the Models 20 execute specific tasks, methods or processes relevant to the valuation of an Enterprise 18, and provide corresponding inputs to the Valuation Engine 12 that are used in determining the value of the Enterprise 18. The Valuation Engine 12, in turn, directs and controls the overall operations of the Valuation System 10 and executes the primary processes or methods for determining a value for an Enterprise 18

In this regard, it should be noted that certain of the valuation programs, routines or program modules or Processes 20p and certain of Data 20d that would otherwise be implemented in an Model 20 may reside in or be a part of Valuation Engine 12 for a number of reasons. For example, certain of the programs, routines or program modules or data will be directly associated with or function directly in the primary operations of Valuation Engine 12, such that executing these operations through an Model 20 would significantly effect the performance of the Valuation System 10. Also, the programs or routines may be common to or shared by a number of valuation steps or Models 20, or will change or be updated only infrequently, so that they are more conveniently implemented in the Valuation Engine 12. Others of Processes 20p and Data 20d will, of course, reside in one or more of Valuation Modules 20 because they are directly associated with or function directly in the operations of the Model 20, or are used only by that Model 20, or will changed or updated as part of the Model 20. It will be recognized, therefore, that the implementation of an Valuation System 10 as an Valuation Engine 12 and one or more Models 20 provides the greatest flexibility in constructing, modifying and updating the Valuation System 10. It should also be noted that certain of Data 20d may reside in separate databases and may be extracted therefrom by, for example, Input Data Parser 14I as required.

As indicated in FIG. 1, the results of the operations of Valuation Engine 12 and Models 20 on the Enterprise Input Data 16 pertaining to an Enterprise 18V may be provided by Report Generator 14O in several forms, indicated as Valuation Outputs 22A . . . 22n, and generally as Valuation Outputs 22. The contents, form and organization of Valuation Outputs 22 depend upon the information or form of information desired from the valuation and the valuation operations that have consequently been performed by Valuation Engine 12. For example, Valuation Outputs 22 may include, jointly or individually, a full report of the value of the Enterprise 18V, with supporting data and intermediate results, or a “snapshot” report briefly stating the value and financial condition of the Enterprise 18V but without full detail. Yet another Valuation Output 22 may be a “recommendations for maximization” report containing recommendations for maximization of the value of the Enterprise 18V, or of selected aspects of the Enterprise 18V. Valuation Outputs 22 may further include the detailed results which may then be re-run based on different data inputs and compared to previous runs which incorporated different data. It should also be noted, in this regard, that because of the structure and operation of a Valuation System 10 wherein the primary operations are distributed among a number of Models 20 and wherein the Models 20 are structured to use a number of pre-assembled databases in the valuations, a Valuation System 10 is capable of performing a valuation of an enterprise in real time, that is, within a very short period after the necessary data has been provided to the system.

In summary, and as will be described in detail in the following discussions, the function of Input Data Parser 14I is to extract standardized, defined data from standardized sources of data. The function of Valuation Engine 12 and Models 20 is to generate values representing various aspects of an Enterprise 18 from the parsed input data and from pre-assembled collections or bodies of data pertaining to economic factors and conditions that may, for example, be extracted or assembled from standard sources of economic data. The values generated by Valuation Engine 12 and Models 20 are determined to be those that may be required or used in generating a wide range of reports, or Valuation Outputs 22. Finally, the function of Report Generator 14O is to generated defined reports from the various forms of information generated by the Valuation Engine 12 and Models 20.

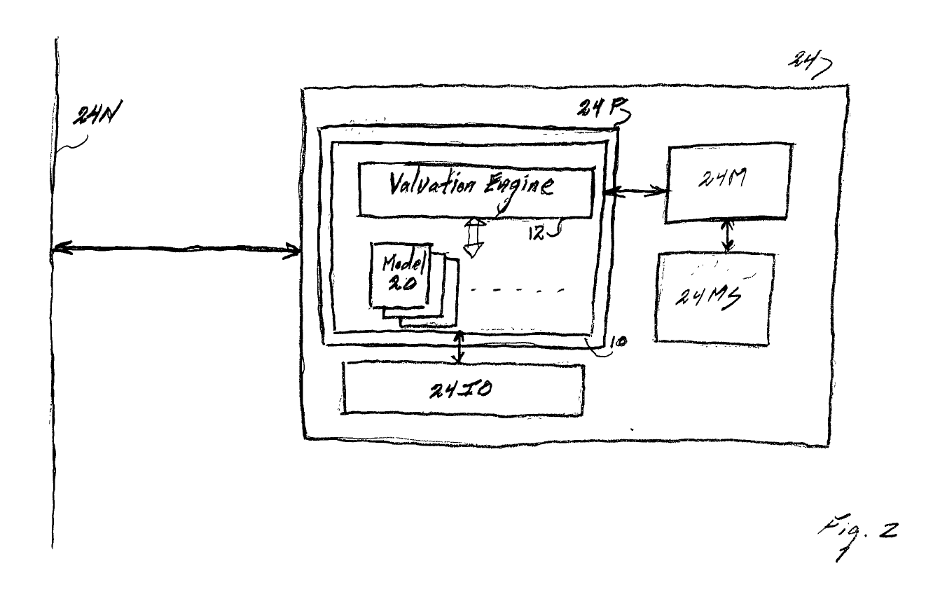

B. Overall Description of the implementation of an Valuation System 10 in a Computer System 24 (FIG. 2)

Referring briefly to FIG. 2 before continuing with a detailed description of the method and mechanisms of the present invention, the mechanisms and data structures of the present invention, that is, Enterprise Engine 14 and Enterprise Models 20, are typically implemented on a Computer System 24. As illustrated, a Computer System 24 will typically include a Processor Unit 24P for performing the operations of Valuation Engine 12 and Models 20, a Memory 24M and Mass Storage 24MS for storing the data and programs of Valuation Engine 12 and Models 20, and an Input/Output Subsystem 24IO through which Enterprise Input Data is provided to the Valuation System 10 and through which Valuation Outputs 22 are returned. Input/Output Subsystem 24IO also provides input and output facilities and devices through which the system may be controlled.

It will be recognized and understood that Valuation System 10 may be implemented in a stand-alone Computer System 24, or in a Computer System 24 connected from a Network 24N, through which clients or other users of the Valuation System 10 may access and utilize the Valuation System 10. For example, Network 24N may include or be comprised of the Internet, and the services and operations of Valuation System 10 may be provided to clients on the Internet. In other implementations, the Network 24N may be internal to a company or other enterprise, such as a financial and investment company, and shared among users within that enterprise, and so on.

Returning now to FIG. 1, the following descriptions will describe the data structures and operational and functional mechanisms of Valuation Engine 12 and Enterprise Models 20 in further detail, and will describe the processes or steps of the method of the present invention in further detail. It should be noted that the following discussions will include terms and references common to the financial and economic arts, but will use only terms and references well known to those of ordinary skill in the financial and economic arts.

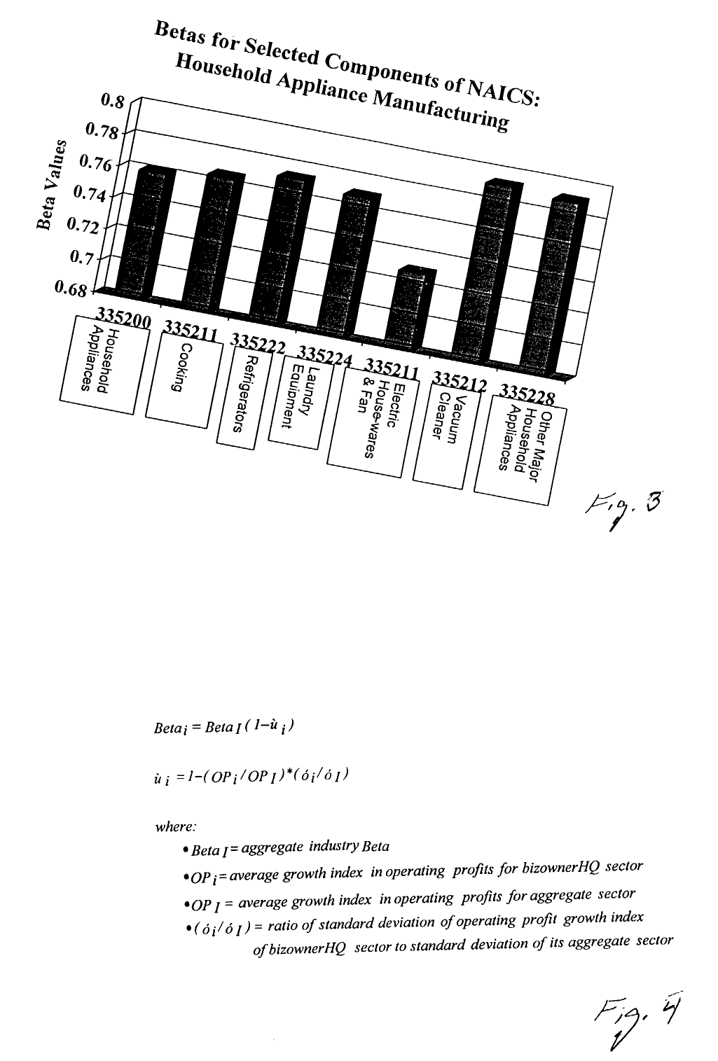

C. Description of Valuation Mechanisms and Methods (FIGS. 1 and 3)

1. Introduction

As described in briefly above, an Valuation System 10 includes an Input Data Parser 14I which parses Valuation Input Data 16 to provide data inputs representing an Enterprise 18 to the Valuation Engine 12, which in turn provides selected data items to one or more of a plurality of Models 20, each of which performs operations for determining financial or economic variable pertaining to the valuation of the Enterprise 18. Models 20 include both processes, or sequences of method steps, for determining valuation variables and values, and underlying data for a large plurality of industries, for example, on the order of hundreds or a thousand industries. The Valuation Engine 12 and Models 20 may thereby consider both the unique aspects of a given Enterprise 18, the aspects of that Enterprise 18 in the context of any of a large number of industries, and the aspects of that Enterprise 18 as a member of a specific industry.

In this regard, it must be noted that in a present preferred embodiment of Valuation System 10, the Valuation Engine 12 and the Models 20 are implemented and adapted for the valuation of both privately and publicly held Enterprises 18, that is, either a privately owned or controlled Enterprise 18 or a publicly owned and controlled Enterprise 18, and the aspects and adaptations of Valuation System 10 for such Enterprises 18 will be discussed in detail in the following.

In a presently preferred embodiment of an Valuation System 10, the results of the operations of Valuation System 10, Valuation Outputs 22, are generated in a range of definable formats, or reports. These reports may include, for example:

a) A Valuation Snapshot Report, which is a brief overview of the valuation results that focuses on the fair market value of the business, the sources of this value—whether the value comes from operating activities of the business and/or non-operating assets, and what the ownership value of the business is after all debt and other liabilities are paid off.

b) A Value Maximizer Report, which is a report that extends beyond the question of how much the business is worth and shows how to increase the value of the business through: a) moving to a higher operating profit growth path; b) altering the firm's capital structure, i.e., altering the amount of debt the firm uses to finance the firm's asset base; and, c) focusing on exit planning strategies, including finding a strategic buyer, finding a buyer without using a business broker, and shifting from a tax minimization to a value maximization strategy; and,

c) A Valuation Report, which is a detailed analysis of the factors determining the value of the owner's business.

It will be recognized and understood, however, that the range and types of reports that may be generated by the Report Generator 14O may vary widely and will depend in part upon the types of Models 20 implemented in an Valuation System 10, and thus the range and types of valuation data and factors that may be generated by the Valuation Engine 12 and Models 20.

The following discussions and descriptions of the method and mechanisms of the present invention for valuation of the value of an Enterprise will refer again to FIG. 1 with regard to elements and operations of the valuation mechanism and in discussion of the processes and methods of the present invention. In this regard, FIG. 1 illustrates the functional elements and structure of a Valuation System 10, and in particular the Valuation Engine 12, Models 20, Input Data Parser 14I and Report Generator 14O, and the flow of operations, data and results among those elements in performing a valuation of an enterprise.

2. Input Data

Referring to FIG. 1, it is described above that in the presently preferred embodiment of an Valuation Engine 12, Valuation Input Data 16 is comprised of data extracted from selected fields of one or more selected, standard Federal tax returns of the Enterprise 18V to be valuated. Although Valuation Input Data 16 may include other data, from other sources, the use of information extracted from Federal tax returns eliminates certain of the problems of the prior art in determining the value of an Enterprise 18. For example, the use of specified tax return data ensures that all valuations are performed using the same, comparatively defined data. In addition, the use of data from standard tax returns significantly reduces the variability's in the data upon which an valuation is based, differences in theory or opinion as to which data should enter into an valuation, variations in how the data is weighted or used, what the data means, and how the data is to be interpreted. In effect, the valuation data is uniform and comparable between valuations and the meaning and interpretation of each data element is defined and fixed, in so far as is possible, by the Federal tax codes and laws.

3. Enterprise Valuation, Methods and Mechanisms

The following descriptions and discussions will describe the mechanisms and methods by which an Valuation System 10 generates various aspects, factors and values of interest and use in valuating an Enterprise 18. The following discussion of the methods and mechanisms of an Valuation System 10 are discussed in terms of one or more sequences of method steps, and the mechanisms involved are discussed in the context of the various methods or method steps. It will be recognized and understood by those of ordinary skill in the relevant arts that the following methods and the process steps comprising the methods are described generally in the sequence in which the steps are performed. It will also be recognized, however, that certain of the methods or the steps thereof are sequence independent. That is, the generation or determination of certain factors, aspects or values to be used in generating a valuation of an Enterprise 18 are independent of the sequence in which other methods or method steps are performed. The organization and sequence of the steps in the following discussions and descriptions are not in general, therefore, to be taken as limiting of the overall method or mechanism, or of any part thereof.

a. Parsing of Input Data:

Valuation Input Data 16 is is provided to the Valuation System 10 by the Input Data Parser 14I, which locates and searches a source of data and extracts specified data or types of data from the sources. In the presently preferred embodiment of a Valuation System 10, for example, Valuation Input Data 16 will include data extracted from Tax Returns 28, which will provided as data input to Valuation Engine 12. The Valuation Input Data 16 extracted by Input Data Parser 14I may includes still other types of data from other sources, such as data from other forms of reports having a sufficient confidence level and level and assurance of definition. Other sources and types of Valuation Input Data 16 may include, for example, the answers to questions pertaining to the enterprise that are presented to a user by the Valuation System 10, and data extracted from external databases, such as databases representing industry, financial or economic studies, surveys, compilations and so on. In certain implementations, the Input Data Parser 14I may include the mechanisms to search a network or databases, either directly or through a network, for identified sources of data or types of sources of data and to extract the desired data from those sources. Possible examples of such sources are mentioned in the following descriptions, but are not limited to such sources and may not include the mentioned sources, for various reasons, and the examples of such search mechanisms are known in the prior art, or new search mechanisms may be developed specifically for Valuation Systems 10.

b. CEO Compensation Factors:

Valuation Engine 12 utilizes a CEO Compensation Model 20A, to determine a reported officer's compensation expense as percentage of net receipts and compare this value to a benchmark value from the CEO Compensation Model 20A.

This step is performed using the compensation of the CEO of the enterprise because the CEO's salary typically represents two separate components: (1) the salary necessary to pay someone of the appropriate skill level to perform the CEO's duties; and (2) the compensation over and above necessary salary which represents return to capital or profit of the firm which the CEO is receiving as salary. Thus the CEO's reported salary is benchmarked to other CEO's according to industry at a 6 digit NAICS industry level of detail, by firm size and by state location of the firm's headquarters in order to determine what represents the CEO's salary component and what represents return to capital or profit.

If the reported percentage is higher then the benchmark, then this difference is multiplied by net receipts is added to taxable income, and the value stored for use in a subsequent step of the process, as discussed in the following.

Valuation Engine 12 utilizes an Owner Discretionary Expense Adjustment Model 26G to determine the appropriate level of expense, for a wide variety of expense categories, for a firm of Enterprise 18's size in Enterprise 18's industry (i.e. a benchmark firm). Through a User Interface 14U the user is then free to use the benchmark firm level of expense, adjust the expense to some other level, or leave the expense level as originally reported. Depending on whether the expenses are increased or decreased, the Owner Discretionary Expense Adjustment Model increases or decreases the level of taxable income as appropriate and the value is stored for use in subsequent steps of the process as discussed in the following

A Firm Gravity Model 26K locates the firm within an MSA based on its zip code identifier. The gravity model uses a numeric code evaluation technique to match zip codes not within an MSA to the closest MSA to which it is economically tied. This may be an MSA that is in a nearby state and not the state in which the corporate offices are located because the market for resources and talent pool is more closely tied to the identified MSA, which is not necessarily state specific. These decision points are critical to the accuracy of any valuation since input values must accurately reflect the economic resource constraints the firm faces. These issues are generally less important for large public firms drawing resources from a global marketplace and are far more critical to firms that have a much smaller sphere of influence, have customers that are relatively close by and are subject to resource constraints that in the main are location specific.

c. Operating/Non-Operating Income:

The next stage of the analysis separates operating income from non-operating income, and non-operating income is further subdivided into two components—taxable and non-taxable income. The distinction between two operating income concepts is critical to an accurate and consist firm valuation. For purposes of the valuation of an Enterprise 18V, non-taxable income is essentially tax-exempt interest and taxable non-operating income includes interest, dividend and royalty income. These income flows are generally independent of the income flows that are related to the economic performance of the business and as a result must be valued using different valuation factors. The Valuation Engine 12 is made aware of these differences and applies a different set of valuation factors to them.

d. Tax Shield:

The taxable operating income is then reduced by an estimated 40% federal and state income tax rate and by an amount of referred to and defined as the “tax shield”, wherein a tax shield arises when a firm finances part of their asset base with debt interest, which is treated as an expense for tax purposes.

To fully reflect the value of the operating assets, rather than how the assets are financed, the Valuation Engine 12 calculates the tax liability as the tax paid plus the value of the tax shield, which is equal to the firm's marginal tax rate multiplied by the interest on the firm's debt. This amount the represents what the firm saves in taxes as a result of the firm financing with debt rather than equity.

e. Operating Profit:

The Valuation Engine 13 then adds interest expense to after-tax operating income to obtain operating profit.

f. Expected Operating Profits:

The Valuation Engine 12 then “moves forward” the operating profit, using the expected growth in operating profits for the industry in which the Enterprise 18V operates. The firm's industry is identified by the Firm to Industry Identification Model 26 discussed above. Once the industry is identified, the system moves to choosing the growth trajectory that best reflects the expected performance of the firm.

In this regard, there are three operating profit growth and revenue trajectories for each industry, the trajectories reflecting the fact that a firm can be on the high, median or low growth path. At this step, through the Firm Growth Trajectory Model 26M the user can choose one of the three trajectories as the appropriate path, or the Firm Growth Trajectory Model can select an appropriate path based on the user's responses to a number of questions presented to the user by the Valuation Engine 12. The evaluation of these responses is consistent with the performance of firms within an industry and within a growth segment within an industry. Each industry is made up of several growth segments. These segments reflect the fact that an industry is made up of firms that are on different growth trajectories reflecting, among other things, the quality of firm a management, market acceptance of products and services and the intellectual property that allows the firm to produce in the most efficient manner possible given the technological constraints that firms within the industry face. The responses by the user indicate whether the firm has success factors that indicate it is more like a high, median or low growth firm within the industry. The growth paths determined by the Firm Growth Trajectory Model 26M, and the interaction between the Operating Profit Margin Model 26J and the Industry Revenue Model 20L, yield the correct operating profit and revenue growth trajectory for the firm being valued. The basic macro economic inputs for these models can come from multiple sources of macroeconomic data.

At this point, it must be noted that because the determination of operating profit factors and values is intertwined with the operation of several other Models 20, and the determination of several other factors, aspects and values pertaining to the Enterprise 20, a further detailed discussion of Operating Profits Model 20B is provided after the present discussion of an Valuation System 10.

The Valuation Engine 12 applies the operating profit growth factors selected by the Valuation Engine 12 to the Enterprise 18V firm operating profits to determine expectations of future operating profit values over a period designated as the “competitive advantage period”. The competitive advantage period is an assumed period over which the firm will earn a rate of return on its investments that exceed its cost of capital and, in a present embodiment, is assumed to be five years.

g. Firm Growth:

The Valuation Engine 12 performs a sequence of operations to reflect the fact that firm is growing and to determine the expected growth of the firm. For this purpose, the Valuation Engine 12 first estimates net capital expenditures (gross investment less depreciation), from Valuation Input Data 16, and the anticipated change in working capital for each year of the competitive advantage period, wherein these factors are determined under the assumption that additions to net fixed capital and working capital grow at the same rate as projected revenue, using Capital Expenditure and Working Capital Model 20C.

h. Free Cash Flow:

The capital expenditure and change in net working capital values estimated for each year are then subtracted from their companion operating profit value for each year to determine the firm's anticipated free cash flow for each year of the competitive advantage period.

i. Perpetuity Free Cash Flow:

The firm's perpetuity free cash flow is calculated at the end of the competitive advantage period wherein this cash flow is equal to the expected operating profit value at the end of the competitive advantage period multiplied by the firm's expected operating profit long-term growth rate.

This growth rate is determined as equal to the expected growth of the economy for firms on the median growth path, as 2% above the economy's growth for firms that are and expected to remain on the high trajectory and as 1% below the economy's growth path for firms that are on the low growth trajectory.

j. Cost of Capital:

The Valuation Engine 12 then estimate the cost of capital to the Enterprise 18V, using a model developed to reflect various industries and size-specific costs of capital for various sizes of Enterprise 18. These factors are represented in the Industry Systemic Risk Model 20C. The construction of the Risk Model 20C incorporates industry unlevered “Betas” from an appropriate source, such as illustrated in FIG. 4.

It must be noted that the “Betas” so obtained are not used directly, but are used as data into a second set of Models 20, that is, Industry Systemic Risk Model 20C, also referred to as Beta Model 20C, that yield unlevered Betas for each of a selected set of more detailed industry sectors.

k. Equity Cost of Capital:

The Valuation Engine 12 uses Beta information from the Systemic Risk Model 20D and Cost of Capital Model 20E in estimating the firm's equity cost of capital. The values obtained from the Models 20D and 20E are adjusted for size based on firm revenue and are further adjusted using the “Hamada” relationship if the firm in question has debt.

The cost of preferred stock is then set equal to the firm's cost of firm common equity less 2.5% because the cost of preferred stock is less risky than common stock and preferred stock should therefore have a lower cost than common equity. The 2.5% differential is chosen as reflecting the results of research performed in the development of the Valuation System 10, but may vary depending upon the results of other or further research.

I. Long Term/Short Term Debt:

The Valuation System 10 the develops the costs of short-term and long-term debt separately.

In this regard, the Small Business Administration indicates that the cost of short-term debt varies with the prime rate plus a size risk premium of 2.5%. Short-term debt cost is thereby equal to the 1 year Treasury bill rate plus the spread of the prime rate over the one year Treasury bond rate plus a 2.5% size risk premium.

The Valuation Engine 12 determines the cost of long-term debt as a function of four factors, which are conventionally identified as (a) the cost of short-term debt, (b) the firm's credit rating, (c) the spread over 10 year Treasury bonds for the credit rating in question, and (d) a maturity risk premium equal to the difference between the 10 year Treasury bond and the one year Treasury bill rate.

In these operations, the Valuation Engine 12 employs a Firm Credit Risk Rating Model 20F wherein an Enterprise 18 credit rating is based on the firm's interest coverage ratio, wherein interest coverage is defined as earnings before interest and tax/interest expense. In this regard, it must be noted that although there are more complicated models of firm credit risk, experience obtained in development of the Valuation System 10 indicates that interest coverage is the most important determinant of a firm's credit risk.

Given an Enterprise 18V credit risk rating, the Valuation Engine 12 then uses a Bond Matrix 20G to calculate the size of the spread over 10 year Treasury bonds to reflect the additional return investors require to accept the indicated degree of credit risk.

m. Systemic Credit Risk:

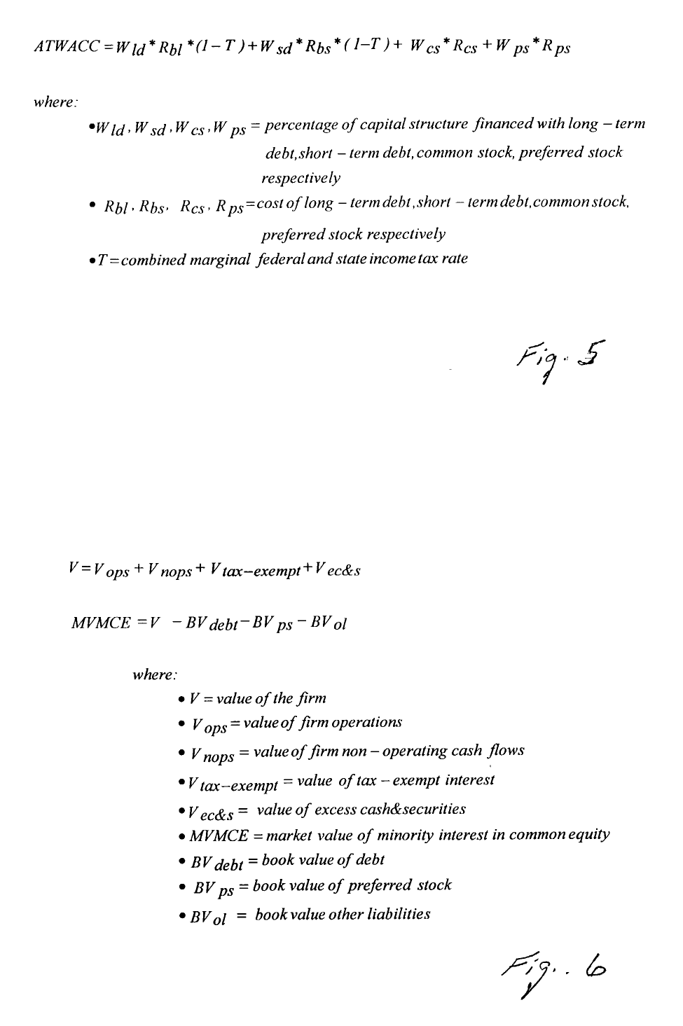

The Valuation Engine 12 valuates the systemic credit risk using Systemic Risk Rating Model 20E wherein systemic risk is measured and represented by “Beta” values. As discussed above, Betas for various industries may be obtained from various sources, such as illustrated in FIG. 4. The Valuation System 10 employs such Beta information with detailed industry operating profit growth data to estimate Betas at the level of industry detail desired for use in the Valuation System 10. In this regard, an example of a Systemic Risk Rating Model 20D is illustrated in FIG. 5 and a basic Model 20 for an industry systemic risk may be represented by the expression shown in FIG. 4.

As FIG. 4 indicates, there is some variation of component Betas around an industry aggregate, and this variation reflects the fact that the variability in the operating profit growth of individual sectors is different from that of the aggregate they are in. While the size of this variation may not seem large, it could alter the value of the equity cost of capital by more than one half of a percentage point from 10% to 10.5% for example, and this difference could have a substantive impact on the value of the Enterprise 18. In the example, the increase in the cost of capital of 0.5% could reduce the value of the firm by close to 5%, which not an insignificant amount.

o. Average Cost of Capital:

The Valuation Engine 12 employs a Cost of Capital Model 20E to determine an Enterprise 18 after-tax weighted average cost of capital (ATWACC) according to the expression shown in FIG. 6.

In these operations it should be noted that loans from owners are treated as equity because these loans represent an increase in owner financing where the dividend, booked as interest, is tax deductible. The process of the present invention makes no adjustments to the firm's reported interest expense, however, since this benefit is adjusted for through the addition of the tax shield to the firm's calculated tax liability, as discussed herein above.

p. Value V for the Enterprise:

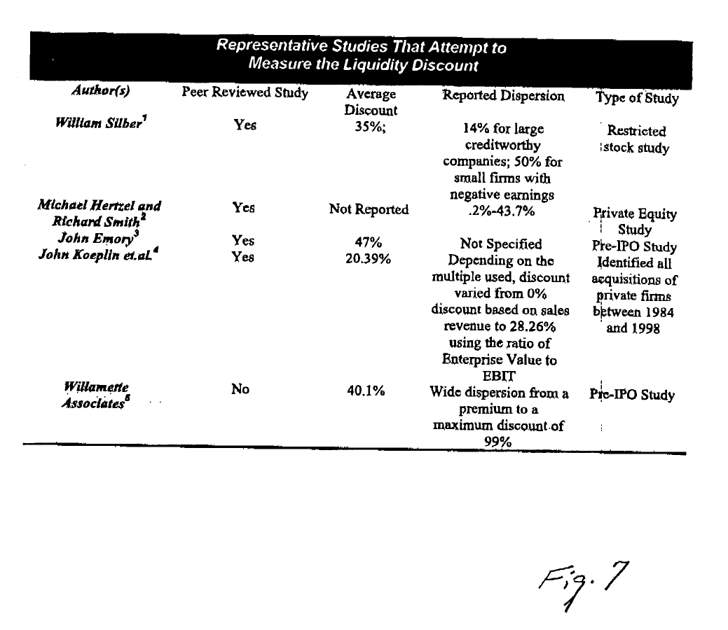

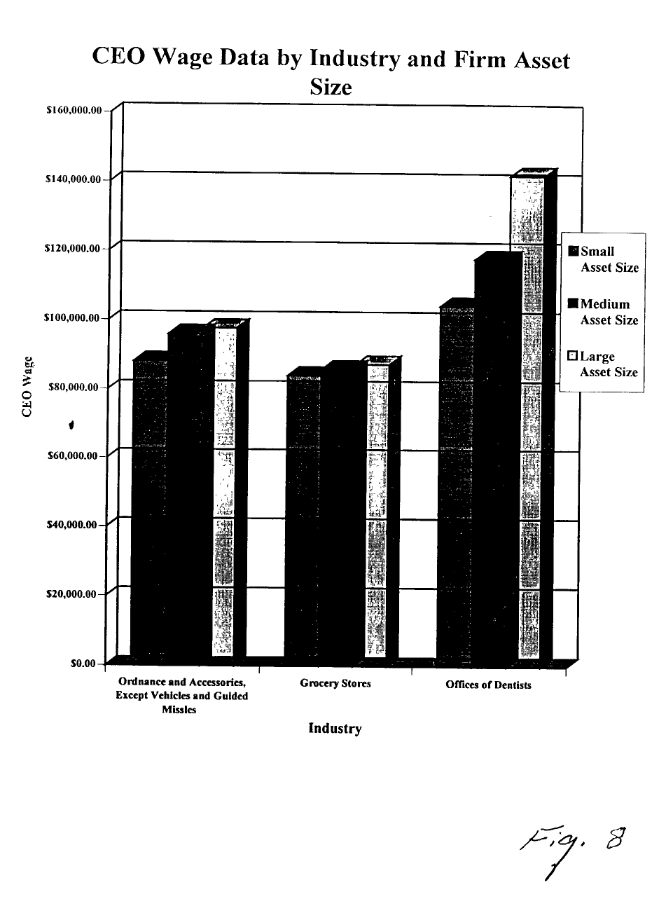

The Valuation Engine 12 determines a value V of the Enterprise 18V according to the expression illustrated in FIG. 7.

q. Control Premium:

The Valuation Engine 12 employs a Control Premium Model 20 and associated Models 20 to determine a “control premium” based upon the above described factors and values.

In this regard, and according to the present invention, a minority value of ownership in a privately held company is equivalent to owning a share of stock of a public company. Ownership of this “minority value” stock conveys a type of ownership in the company in that the owner can vote on various agenda items presented at the annual meeting of stockholders and has a right to the pro-rata share of the firm's earnings. This minority value ownership, however, does not include the right to manage the assets of the firm directly. Only majority owners have this right, that is, to manage the assets of the firm directly, and thus this right to control the assets of the company directly has a value separate from the value of the common equity itself.

The value of this right of control is defined, according to the present invention, as a “control premium”. The control premium quantitatively represents a markup on the market value of the minority interest in the common equity and is an additional sum that an investor would pay above the fair market value of a minority interest of the firm in question. For example, if a share of common stock of a public company is selling for $100, and an investor is willing to purchase all shares for $140 per share, the control premium is 40%.

There are multiple factors that determine a control premium, such as:

1) The nature and magnitude of business non-operating assets;

2) The quality of management;

3) Synergies between the buying and target firm, which may include removal of overlapping functions and therefore reducing expenses per dollar of revenue; and,

4) Taking advantage of growth opportunities that would either not be possible or highly expensive to take advantage of without purchasing the assets of the target firm.

Control Premium Model 20H incorporates several factors in determining a control premium, including a firm's business risk, which is directly related to the industry the firm is in as well as the firm's size and capital structure.

The methods implemented in an Valuation System 10 for determining a control premium, and Control Premium Model 20H, are discussed further in a following detailed description of control premiums and of Control Premium Model 20H.

r. Liquidity Discount:

Valuation System 10 includes a Liquidity Discount Model 20I for determining a “liquidity discount” for the Enterprise 18V being valuated.

A “liquidity discount” is defined for the present invention as a value reducing the ownership value to reflect the fact that an ownership interest cannot be easily sold. Stated another way, any potential buyer of the ownership value faces the risk that the buyer cannot sell the ownership interest in a timely way because there are a limited number of potential buyers. The sale or purchase of ownership of a privately held Enterprise 18 is thereby contrasted, for example, to shares of stock that trade on the New York Stock Exchange as these shares can be readily purchased and sold and, except for rare cases, the price received will reflect the fair market value of these shares.

Thus, a liquidity discount reflects the additional risk that the buyer faces because the buyer may not be able to receive a price that would be obtained if the ownership interests were sold in a highly liquid market.

Although there have been significant efforts to define liquidity discounts, to measure liquidity discounts, and to determine a method for determining liquidity discounts, the values traditionally reported are far too high. The reason for this systemic error in determining liquidity discount is that is that what is observed, generated and reported as a “marketability” or “liquidity” discount is in fact a “private company” discount. A “private company” discount relates to the enterprise as a type of business entity, that is, as private company, rather than to the liquidity of the market for the purchase and sale of a private company. As a result, this private company discount reflects a number of factors that are not related to lack of liquidity.

In this regard, it must be noted and understood that the differences between private firm valuations and those of public peers can occur because of differing cash flow growth prospects, timing of cash flows and differing ratios of debt to equity. The result is that reported discounts for marketability are certainly biased and for a number of reasons are likely to be too high. This in turn means that private company valuations that use “private company” discounts are probably too low and in any event will tend to be less accurate than is actually achievable using an appropriate market “liquidity” discount.

Examples of typical “liquidity discount” values are shown in FIG. 8, wherein it may be seen that there is significant variation in private company discounts with the methods of the prior art. These results, however, are relatively consistent as virtually all methods and systems for determining these values operate from the same principles.

According to the present invention, however, these discount values appear to be significantly too high in view of actual observed results and do not appear to actually represent the lack of liquidity, that is, the difficulty of buying or sells, a private firm.

For these reasons, the Valuation System 10 of the present invention employs methods for determining a liquidity discount that controls for capital structure differences and that considers whether the selection of a private company's peers were in reasonably similar industries, as indicated by whether the companies are in the same four digit SIC industry.

Based on these principles and methods, a presently preferred embodiment of an Valuation System 10 employs a liquidity discount of 20%.

s. Report Generator 14O, Valuation Outputs 22:

As has been described herein above, the results of the operations of Valuation Engine 12 and Models 20 on Enterprise Input Data 16 may be provided by Report Generator 14O in several forms as Valuation Outputs 22. The contents, form and organization of Valuation Outputs 22 depend upon the information or form of information desired from the valuation and the valuation operations that have consequently been performed by Valuation Engine 12.

In a presently preferred embodiment of an Valuation System 10, for example, Valuation Outputs 22 may be generated in a range of definable formats, or reports, which may, for example, include a valuation snapshot report, a value maximizer report, or a valuation report.

It will be recognized and understood, however, that the range and types of reports that may be generated by the Report Generator 14O will depend upon the range and types of valuation of data and factors that may be performed by the Valuation Engine 12 and the Models 20, and thereby upon the types of Models 20 implemented in an Valuation System 10. It will thereby be recognized that different forms or types of Models 20 representing and valuing different types of factors, aspects and values pertaining to enterprises may be implemented in an Valuation System 10.

In conclusion and summary, therefore, and as described, the function of Input Data Parser 14I is to extract standardized, defined data from standardized, widely accepted and trusted sources of data. Such data sources include, for example, enterprise specific data, such as user input tax data and user answers to certain questions, and sources of a more macro-economic nature, such as sources reporting on industries or the economy is a whole, which may be incorporated into Models 20 or extracted as needed from databases by Input Data Parser 14I. The function of Valuation Engine 12 and Models 20, in turn, is to generate, from the parsed input data, values representing various aspects of an Enterprise 18, and that the function of Report Generator 14O is to generate Valuation Outputs 22 from the various forms of information generated by the Valuation Engine 12 and Models 20.

4. Further Detailed Descriptions of Methods and Mechanisms

a. CEO Compensation Model 20A

Unlike public firms, private firms are typically managed by the owners and, in this capacity they can set their own compensation, so that the compensation of an officers or partners typically reflects both a wage and a bonus based on firm performance.

Such bonuses are treated as an expense of the firm, which is legally permissible and allowed in accounting practice, but such bonuses are in fact and in effect a return to capital and, for purposes of business valuation, it is necessary to separate wages from the total compensation owners, officers and partners receive.

The Valuation System 10 of the present invention identifies owner, officer and partner wages separately from total compensation by means of processes that consider and vary by detailed industry, firm asset size and state location of the business. In brief, the process is based in part upon CEO wage data for three digit Standard Industrial Classification industries obtained, for example, from the Bureau of Labor Statistics Occupation Employment Survey for the most recent available year and, again for example, the OES National Industry-Specific Occupational Employment and Wage Estimates for the most recent available year. These data are updated to reflect the current year, using the aggregate employment cost index.

The resulting data is then de-aggregated by taking the ratio of labor cost share, that is, labor costs to nominal output, for an industry to the labor cost share for its three digit SIC aggregate. In addition, manufacturing labor cost ratios are defined as payroll divided by nominal industry output, and in non-manufacturing industries, where direct payroll data is not available, the labor cost ratio is defined as the sum of nominal output minus operating profits, divided by nominal output.

A value, CEOi, is then determined as CEOₗ*(LCᵢ/LCₗ) wherein the bracketed term is defined as the ratio of labor cost for an industry i to its three digit SIC industry.

The process is based on the assumption that, for most non-manufacturing industries, material and service costs are a small part of total cost and thus variation in total cost predominately reflects wage costs.

It is also known that CEO/officer/partner wages vary by firm size as well as industry. In order to account for this, the Valuation System 10 employs data representing CEO/officer/partner wages and compensation. Such information is preferably drawn from trusted, widely accepted and available sources, an example of which may be the Almanac of Business and Industrial Financial Ratios by Leo Troy, which reports the ratio of officer's compensation to revenue for industries at about the three digit SIC level of detail. The use of data from such sources thereby provides a high level of confidence that different valuations are performed with comparable data, and allows more ready comparison with other forms and methods of valuation.

Where these data are not complete for all asset size classes, estimation is employed to fill the gaps, by first reviewing the trend of the officer's compensation ratios across asset size classes. In virtually all cases, the ratios became smaller as the asset size class increased. Based on this inverse relationship between asset size class and the magnitude of the officer's compensation ratio, a linear interpolation procedure is used to fill in the blanks, assuming that these results also applied to the more disaggregated business sectors.

It should also be noted, and for example, that the Troy data, discussed above, indicated that there is an inverse relationship between asset size class and the ratio of officer's compensation to revenue. This reflects the fact that an officer's compensation is a larger percentage of costs for smaller firms than larger firms within the same industry. This is also consistent with the CEO wage being lower for CEOs managing smaller resource base businesses than those managing larger resource base businesses.

For these reasons, the average resource base for each asset size class is determined as the officer's compensation ratio multiplied by the reported average revenue for each asset size class, that intermediate result then being subtracted from average revenue to obtain the average resource base for each asset size class.

The average resource base across all asset size classes is then determined, and the ratio of the resource base for each asset size to the resource base average across asset size classes is then calculated.

These processes are executed for all industries represented in the Valuation System 10, with the assumption that this distribution would apply to the more dis-aggregated industry sectors.

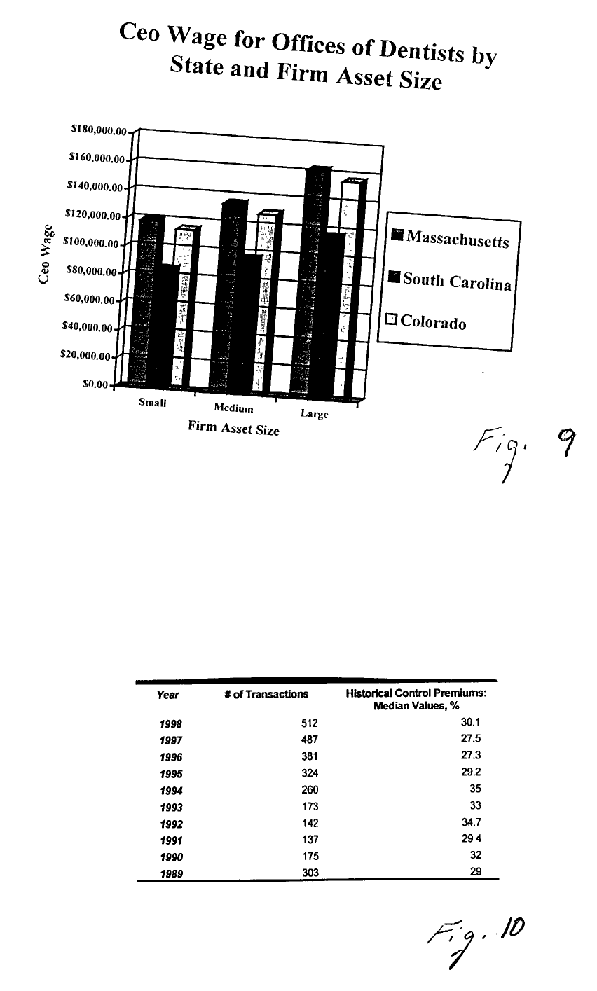

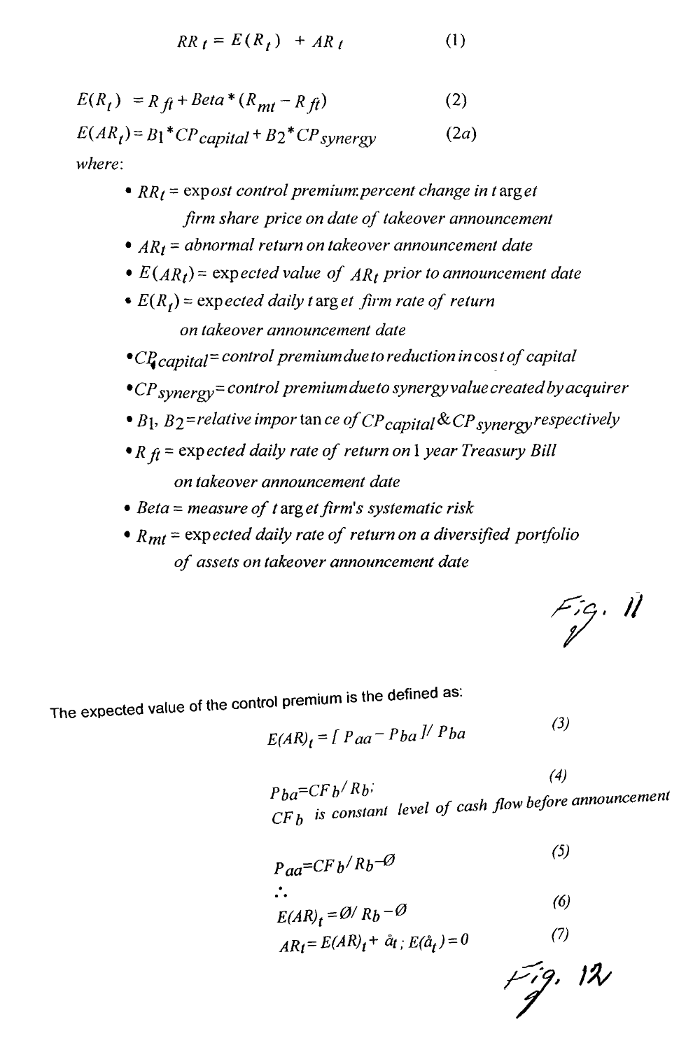

Then, finally, the resource base ratios generated by the above steps are multiplied by the value CEO, discussed above, to obtain CEO wage data by asset size class. These results are then multiplied by state and MSA factors obtained from the OES data set, and the results of this analysis yielded owner wage data by industry, by firm asset size class, and by state. The results of this process by state is illustrated for examples in FIGS. 9 and 10.

b. Control Premium Model 20H

As described, Valuation System 10 includes a Control Premium Model 20H that incorporates several factors in determining a control premium, including a firm's business risk, which is directly related to the industry the firm is in as well as the firm's size and capital structure.

This method is in contrast to that often used by business appraisers who apply a median markup to the minority equity value to obtain the majority equity value, as there are several problems with the conventional methods.

First considering basic sources of data for determining control premiums, a typical example of a source of such information regarding median values and related control premium statistics may be the annual Mergerstat Review, which is published by Houlihan Lokey Howard and Zukin of Los Angeles, and which is referred to in brief as “Mergerstat’, although similar sources of such data exist and may also be used. Mergerstat compiles data on publicly announced mergers, acquisitions and divestitures involving operating entities, where the transfer involves at least 10% of the subject company's equity, the purchase price is at least $1 million, and where at least one of the parties to the transaction is a US entity. Mergerstat is also a source for data on control premiums by industry, but only at a very aggregate level, and for data for individual firm transactions. Again, the use of data from such sources thereby provides a high level of confidence that different valuations are performed with comparable data, and allows more ready comparison with other forms and methods of valuation.

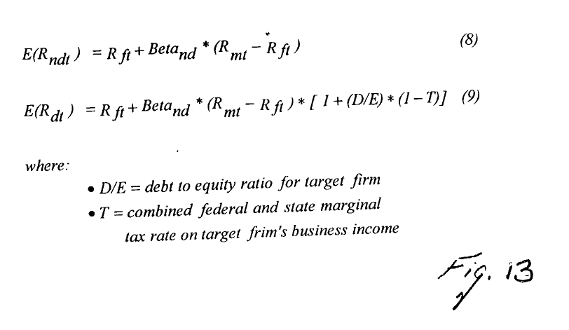

FIG. 11 illustrates the effects that median control values may have on the value of an enterprise over time. As may be seen therein, median control values may vary, in the present example, from a low of 27.3%, in 1996, to a high of 35, 0%, in 1994.

Research has addressed the issue of the factors that determine the values and variations of control premiums, and have in particular addressed the variables of:

1) Method of payment: cash versus stock;

2) Purpose of acquisition: purchase new product line, enter new domestic market and/or foreign market, purchase patents and other intangible asset and take advantage of financial synergies that occur because of the mismatch between liquidity and growth opportunities between target and bidding firms; and,

3) Size of acquirer.

The research, however, has not shown any of the above variables to consistently or reasonably explain the value or variations of control premiums, which encourages caution in blindly applying a median value as a markup factor, given the wide variation of such values. For example, in 1998, and of the 560 transactions reported by Mergerstat, the maximum is 423.5%, the minimum is 0%, the average is 40.4% and the standard deviation is 43.4%, which indicates that there is a high probability that simply applying the median control premium will result in considerable error.

For this reason, a Valuation System 10 of the present invention estimates a control premium directly.

As described, a control premium occurs, or comes into existence, because a buyer wants to acquire full control over the target's assets. How much the acquirer is willing to pay is in turn based on the riskiness of the target's cash flow as a standalone entity and the expected synergy value the buyer expects to create once the target is purchased. In effect, therefore, the buyer may be regarded as setting or defining a price that would reflect the expected value of the target firm's standalone cash flows plus the value of control.

The incremental amount the buyer is willing to pay above the price without control, the minority ownership value, can also be regarded as the price of a call option on control of the target's assets. Once the call is exercised, the firm makes an investment to create the expected synergy value. The net present value of this investment can then be viewed as the expected synergy value created, and this value varies depending on the various strategies bidding firms tend to employ.

From the perspective of valuing a private company not yet “in play”, however, it is essentially impossible to know what the synergy value might be and the expected synergy value component of the control premium therefore can not be estimated. Therefore, and unless the bidders are known, the synergy value cannot be included as part of the expected value of the control premium and, since the reported control premiums include the synergy portion by definition, these cannot be used directly.

In the present embodiment of the present invention in an Valuation System 10, this issue is addressed by first noting that as firms bid for a target, the price of the target firm generally increases, and that this higher price offer can also be viewed as a lower cost of capital for the target firm.

Considering, therefore, the relationships represented by the expression shown in FIG. 12, it may first be seen that on any given announcement date, the expected daily return on the target firm is a small percentage of the total return earned by target firm shareholders.

This in turn means that movements in the market on the takeover announcement date do not alter the size of the control premium in any substantive way. Moreover, the factors that determine the size of the control premium, the cost of capital reduction and the synergy value can be viewed as separate and independent factors. This is so because synergy value is determined largely by the acquiring firm, while the cost of capital influence is solely determined by the systemic riskiness of the target's cash flows as a standalone.

Considering first the case where the expected value of synergy is zero, so the cost of capital effect is the sole determinant of the target's control premium, and then assume that on the date prior to the takeover announcement, the target firm has growth possibilities.

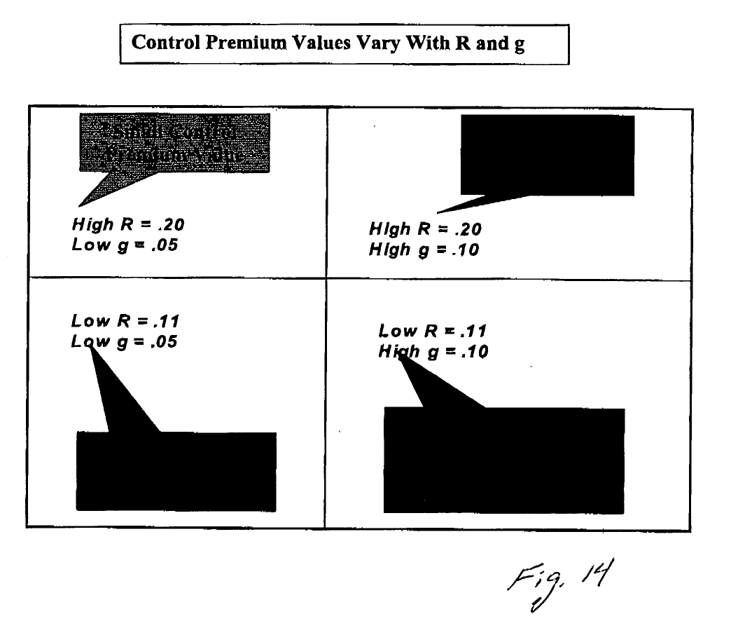

Considering the relationships expressed in FIG. 13, the share price before the takeover announcement is Pba and the share price immediately after the announcement is Paa, and the expected value of the control premium is defined by the expression of FIG. 13.

Considering the results of the above operations, it may be seen that, first, the control premium is essentially a function of the cost of capital, which is determined in Valuation System 10 by the Cost of Capital Model 20E. This in turn means that two firms of equal size in the same industry can have different control premiums if their cost of capital is different, such as if the two firms in question have different capital structures. This may be illustrated by an example in which two firms have different capital structures but are equivalent in every other respect, such as firm D that has debt and firm ND that has no debt.

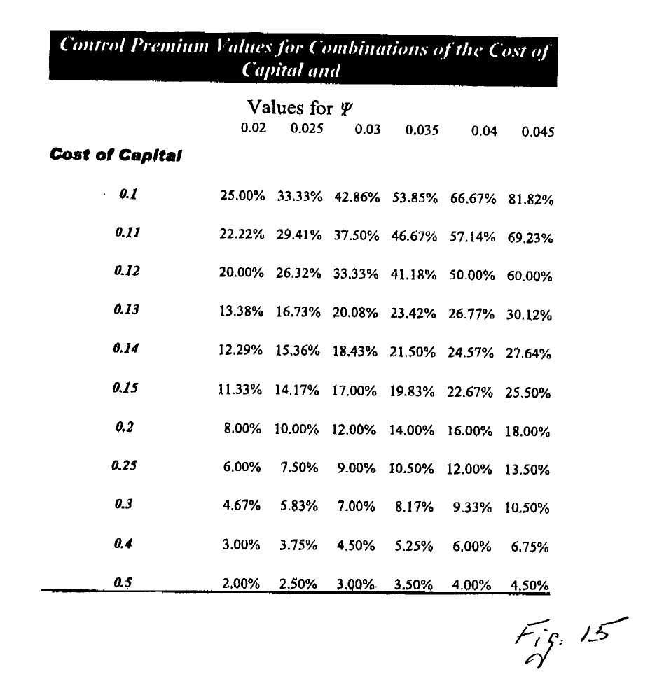

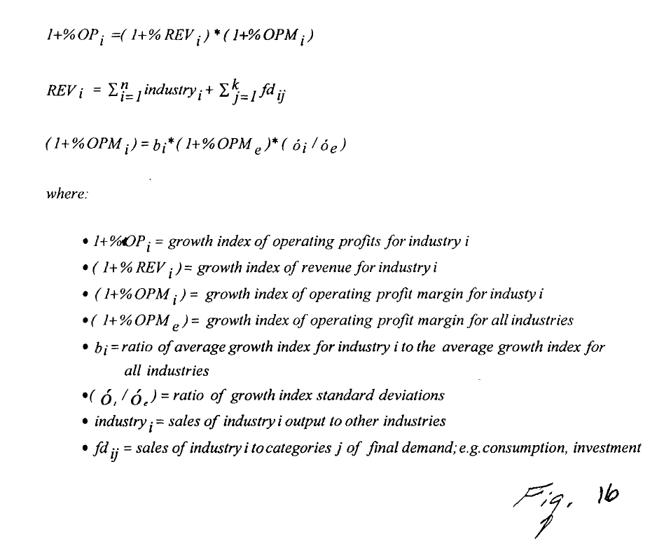

Referring to FIGS. 14 and 15, it may be shown that the cost of equity capital for each firm is different even though their respective business risks, as measured by Beta, are equal, and that the cost of equity capital for firm D will be higher than for ND even though their respective business risks are equal. Thus, ND will have a higher control premium than D, even though they are equivalent firms in all other respects. In the same example in a case where there is growth in the firms, Rb in FIG. 13 is replaced by the differential between the cost of capital, Rb, and g by the long-tem growth in earnings. Thus, the control premium for a firm with a lower cost of capital and a higher long-term earnings growth will be larger than for an equivalent firm that has a higher cost of capital and a lower growth rate.

These examples and principles are illustrated further by the examples shown in FIG. 15, and from these examples it may be seen that, first, two firms can have the same control premium for very different reasons, namely, a high risk, high growth firm can have the same control premium value as a low risk, low growth firm if the differentials are equal. Second, even if a firm is very risky, its control premium can be large because its growth prospects are very high.

It must be remembered, however, that these outcomes are not directly related to any synergy value that the buying firm might be able to create. These outcomes are instead simply the result of a firm wanting to own as opposed to participate in the target firm's earnings growth because owning creates options that simple ownership participation does not.

This means that a control premium should reflect—the value of the option to control the assets of the firm, and that it is the exercise of this option, investing in the synergy, that gives rise to additional value.

Unfortunately, the firm being valuated, that is, the firm that would be the target of an acquisition can have no actual knowledge of what the control premium value might be until potential acquirers declare themselves.

The control premium value must therefore be determined or interpreted by other methods and, as such, it is necessary to consider the best method for interpreting values for F as it appears in the expressions of FIGS. 13 and 14, as this value influences the value of the control premium.

In the simple no growth case, F measures the magnitude of the cost of capital decline, and the size of F is larger the greater the availability of liquidity in the marketplace at the time the buyout is completed.

In the development of the Valuation System 10, control premium values are simulated for a range of values for F and a plausible range for the cost of capital with the object of establishing a value for F that reflected a set of control premiums consistent with values witnessed in 1998, the last year for which data was available at that time.

The criteria for this simulation is to set a range of values for F that yielded a set of control premium values that fell within the average 1998 control premium value of 40.4% and plus or minus one standard deviation of 43.4%.

Using the no growth example, the value of F that yielded results that met the criteria is 4.5, and the results of the experiment as shown in FIG. 16.

c. Operating Profits and Operating Profits Model 20B

As described, a Valuation System 10 employs an Operating Profits Model 20B, which reflects aspects of operating profits for each detailed industry considered by the Valuation System 10.

There are numerous well known and understood sources for the underlying data for these models, and the data sources need not be discussed in further detail. It must be noted, however, that the Operating Profits Model 20B preferably does rely on sources that are firm specific, but rather on the more accurate government and trade association sources of data.

It should also be noted that industry classifications based on allocating public companies are not used for a number of reasons. For example, most public companies are in multiple industries making it virtually impossible to create industry categories that truly reflect the economics of the industry. Also, GAAP reporting standards are very flexible, making company-based industry data subject to unnecessary variation due to variations in the methods and standards by which companies report. In addition, there are numerous industries for which there are no public companies. For example, there are no public firms that are dental or legal practices.

In contrast, the sole disadvantage from employing Government generated or collected data is the question of timeliness, as there is often a significant lag between the time period covered by the data and its publication. The Valuation System 10 of the present invention has in part overcome this shortcoming by a process employing a series of standard updating procedures that overcomes the timeliness issue to a significant degree.

Operating Profits Model 20B creates a time series of operating profits for each of the business or industry sectors considered in the Valuation System 10.

In this regard, and for purposes of the Valuation System 10, operating profits are defined as earnings before tax, interest depreciation and amortization, and represent the gross return to capital from business operations, often expressed as value added less payroll.

Operating profits thereby are the preferential and best measure of the cash generating capacity of a firm or industry, is subject to the least distortions associated with depreciation and amortization policies, and is independent of how the asset base of the firm or industry is financed.

The determination of operating profits for manufacturing sectors is straightforward since the components are published as part of the various editions of the Census and the Annual Survey of Manufacturers. For non-manufacturing sectors, the various censuses and annual surveys for service sectors as well as other service related data sources are a viable source of information. All of the data so developed is, however, benchmarked to government data sources.

d. Determination of Future Cash Flow

As noted above, the development of an Operating Profits Model 20B requires a set of forecasting mechanisms for determining operating profit growth for use in projecting firm operating profits to determine or estimate future cash flow.

In this regard, all business valuations require estimates of future revenue, profits and capital needs, even when applying the simple multiple approach for predicting future revenue. A recurring problem, however, is that the consumer or user of the results of these methods is generally not aware of these requirements, or the methods used. If, for example, the Gordon Shapiro constant growth valuation model is applied, and even if a price earnings multiple of a presumed comparable firm or a median value for a group of comparable firms is applied, there is an implicit assumption that the cost of capital and long term earnings growth of the firm used for comparison are identical to those of the firm being valuated. This is also true if the value were applied to a sales revenue multiple.

In summary, therefore, the ratio of value to sales revenue is a function of the earnings margin, the predicted earnings and the cost of capital. The multiples method, in turn, also depends on predicted values, and on the assumption that those values are in fact identical to those of identified comparable firms, which is most probably a very rare circumstance.

The method implemented by an Valuation System 10 is therefore based upon the proven assumption that the value of any business is related to the growth in its expected cash flows.

The expected cash flows of a firm may, however, be estimated by many methods, one of which is historical performance. This method is based upon the assumption that a history of a firm's cash flow may indicate expected future cash flows. The implication is thereby that if the future replicates the past in some important way, then a firm's historical cash flows may be a guide to the firm's future cash flows.

For example, if the firm's cash flows have grown at 20% per year over the last five years, is it is good assumption that the cash flows will grow by 20% a year for the next five years? The answer is likely to be yes if (1) the economy's future growth allows this to happen and (2) the future growth of the industry the firm is in allows this to happen. This exceptional future 20% growth is not likely to occur, however, if the economy goes through a recession and subsequent slower growth.

As a consequence, it is improbable that a firm's past cash flow growth will be a very good guide to its future performance, which is a conclusion supported by history and by research. For example, several research efforts have shown that less than 2% of the variation in future firm earnings is explained by past earnings and even when modifications were made to the research design, the explained variation did not exceed 10% for most time periods and most cases studied.

In contrast to the historical trends of a single firm, however, studies have indicated that most changes in an individual firm's earnings could be attributed to changes in aggregate corporate earnings and changes in the firm's industry, with aggregate earnings changes being more important.

That is, and although the relative influence of the general economy and the industry on a firm's earnings varied among individual firms, the results consistently demonstrated that the economic environment had a significant effect on firm earnings. For example, studies have indicated that over 40% of a firm's earnings variability is due to economy and industry factors and that this percentage varies significantly by industry with tobacco and cosmetics, for example, having percentages in the 20% range and department stores having a percentage of 67%.

The method implemented in an Valuation System 10 for modeling future cash flow is thereby based upon the effects of economy and industry factors on a firm's cash flow, and Operating Profits Model 20B implements a time series of operating profits and revenue for all of the business activity codes used by the IRS, which includes over 98 detailed industries. The Operating Profits Model 20B includes models forecast future operating profit growth of three segments identified within each of the 98 industries and these operating profit growth forecasts are a function of expected industry revenue and profit margin growth for each industry segment.

Essentially, the operating margin growth forecasting models are developed by relating the operating margin growth for the overall economy to the operating margin growth for each of the three identified segments within each industry considered by the Valuation System 10.

Using these models, forecasts of the operating profit margin for the aggregate business sector, analysts inputs, forecasts of operating profit margin growth are produced for each segment within each industry by an Operating Profit Margin Model 20J and provided to Operating Profits Model 20B. The effects of the economic environment are represented by operation of a Macroeconomic Forecast Model 20K, which provides this information to the Operating Profit Margin Model 20J. Once a firm identifies the segment it is in, therefore, the Valuation System 10 grows the last year of adjusted firm after-tax earnings, using the indicated industry segment's operating profits growth index.

The firm-specific earnings values generated by Operating Profits Model 20I, Operating Profit Margin Model 20J and Macroeconomic Forecast Model 20K are then adjusted by Valuation Engine 12 for the effects in variations in capital expenditures and working capital by reducing them by the change in net fixed capital expenditures and the change in working capital. These two variables, next fixed capital expenditures and working capital, are generated by Firm-Specific Capital Expenditure and Working Capital Models 20C are estimated by assuming that the stock of net fixed and working capital will grow at the rate of expected industry segment revenue.

The method implemented in an Valuation System 10 will thereby generate a set of expected free cash flow values that drive the valuation of the firm in question.

e. Handling of Unusual Events

Although an Valuation System 10 adjusts the tax input data, that is, Valuation Input Data 16, in a number of significant ways in order to represent the cash generating potential of the firm being analyzed, the forecasts of future operating profits start from a base value which is constructed from tax return inputs.

A resulting factor for consideration is the adaptations to the methods for the event of an exceptionally good or bad year; that is, should adjustments be made to normalize this base value. In this regard, and while it is preferable that any large one time events that influence expenses and/or revenue be removed from the Valuation Input Data 16 to better reflect the operations of the business, there is some question as to the significance of normalizing earnings to the accuracy of forecasting future firm earnings.

Normalizing a data series can take several forms, but a normalized value as a starting point is the result of an averaging process of some type. Studies, however, indicate that the method for defining and determining the earnings starting point does not significantly effect the results of the analysis. These results therefore suggest that using the firm's last year of earnings as a starting point for any analysis is consistent with properly forecasting future cash flows.

However, and to reiterate, it is preferable, if the starting point of the analysis includes large one time expense and/or revenue events that a reasonable business person would not expect to continue in the future, then the earnings starting point should be adjusted to reflect the one time nature of the event. For example, many private businesses have non-operating assets that generate cash flow, such as stocks and bonds or royalty bearing patents that result in royalty payments that are not directly related to the operations of the business.

If the firm reported taxable income that included a significant capital gain or loss associated with the sale of one or more of these assets, it would not be appropriate to include this cash flow as part of the starting point cash flow which is being moved forward. If such a one time event were included in the starting point cash flow, the value of the firm would be overstated in the case of a capital gain and understated in the case of a capital loss.

In an Valuation System 10, therefore, such adjustments are made through the Industry Revenue Model 20L, which in effect forecasts what is defined as the “growth index” for operating profits as a function of the revenue and operating profit margin growth index. The operation of the Industry Revenue Model 20L is illustrated by the expression shown in FIG. 17.

f. Final User Adjustments

After all data has been input through the User Interface 14U and a valuation of Enterprise 18 has been obtained, the end-user can employ the User Interface 14U to add or delete other information, which is then revalued by Valuation System 10 and a new firm valuation is then produced.

Finally, and in summary, it has been described and discussed herein above that certain of the operations necessary to valuate an Enterprise 18 according to the methods of the present invention are performed by the various Models 20, while others are performed by Valuation Engine 12. It has also been described and discussed that Valuation Engine 12 operates with the values and factors generated by the Models 20 in various combinations and at various points in the valuation or valuation operations and in different ways to generate the Valuation Outputs 22 containing the desired information for each type of report that may be generated by the Valuation System 10. There are a wide range and variety of methods for generating such Valuation Outputs 22 are well known to those of ordinary skill in the relevant arts given the above discussions and noting the Model 20 operations and outputs discussed above. As such, and because the range and types of such Valuation Outputs 22 that may be defined and generated are very large, the generation of Valuation Outputs 22 need not be discussed further herein.

Wherefore, I/we claim:

1. A valuation system for valuing business enterprises, comprising:
a user interface through which the user is asked to put in selected federal tax return information and to answer a set of standard questions
an input data parser for extracting data representing the enterprise from standard federal tax return information and standard questions answered by the user, all of which data is input through the user interface,
a plurality of models representing financial aspects of enterprises and including data and processes for generating financial values representing the financial aspects of the enterprise from the extracted input data and from the financial values generated by the models,
a valuation engine for providing the extracted input data and the financial values to the models, receiving the financial values from the models and directing operations of the models, and
a report generator for receiving the financial values from the valuation engine and generating from the financial values at least one valuation output representing a value of the enterprise.

2. The valuation system of claim 1, wherein the models include:
an enterprise officer compensation model for determining an enterprise officer's compensation expense of the enterprise.
an owner discretionary expense adjustment model for determining the actual expenses of the enterprise

3. The valuation system of claim 1, wherein the models include:
an operating/non-operating income model for separately determining operating and non-operating incomes of the enterprise.

4. The valuation system of claim 3, wherein the models include:
tax shield model for determining an enterprise tax shield value that is independent of a method by which the enterprise assets are financed.

5. The valuation system of claim 1, wherein the models include:
one or more operating profit models for determining present and expected operating profits of the enterprise.

6. The valuation system of claim 1, wherein the models include:
growth and cash flow models for determining an expected growth in operating profits of the enterprise.

7. The valuation system of claim 1, wherein the models include:
cash flow models for determining enterprise cash flow over a competitive advantage period.

8. The valuation system of claim 1, wherein the models include:
cost of capital models, long and short-term debt models, and systemic and enterprise credit risk models for determining an average cost of capital for the enterprise.

9. The valuation system of claim 1, wherein the models include:
one or more models for generating a control premium value wherein a control premium value represents an increase over a market value of a minority interest in the enterprise represented by ownership of the enterprise.

10. The valuation system of claim 1, wherein the models include:
a liquidity discount model for generating a liquidity discount value representing a decrease in an ownership value of the enterprise due to an increased risk in selling the enterprise arising from the enterprise being a privately owned enterprise.

11. A valuation system for valuing a business enterprise, comprising:
a user interface through which the user is asked to put in selected federal tax return information and to answer a set of standard questions
an input data parser for extracting financial data representing the enterprise from standard federal tax return information,
a plurality of models representing financial aspects of enterprises and including data and processes for generating financial values representing the financial aspects of the enterprise from the extracted input data and from the financial values generated by the models,
the models including:
a Firm to Industry Identification Model for determining, at the most detailed level available, which industry and enterprise operates in.
a Firm Gravity Model for determining the appropriate MSA for the enterprise to determine the geographic area to which the enterprise is most closely economically tied
a CEO Compensation Model for determining an enterprise officer's compensation as an expense of the enterprise,
a Owner Discretionary Expense Adjustment Model for determining the discretionary expense levels consistent with maintaining the on-going operation of the business,
a Firm Growth Trajectory Model for determining an enterprise's revenue and profit growth in order to determine the enterprise's growth trajectory,
value models for determining present and expected values of the enterprise as functions of present and expected profits and costs of the enterprise,
a control premium model for generating a control premium value wherein a control premium value represents an increase over a market value of a minority interest in the enterprise represented by ownership of the enterprise,
a liquidity discount model for generating a liquidity discount value representing a decrease in an ownership value of the enterprise due to an increased risk in selling the enterprise arising from the enterprise being a privately owned enterprise,
a valuation engine for providing the extracted input data and the financial values to the models, receiving the financial values from the models and directing operations of the models, and
a report generator for receiving the financial values from the valuation engine and generating from the financial values at least one valuation output representing a value of the enterprise.

12. In a valuation system including a user interface an input data parser, a plurality of models for generating financial values representing an enterprise, a report generator for generating from the financial values at least one valuation output representing a value of the enterprise, and an valuation engine for directing operations of the valuation system, a method for determining a value of business enterprises, comprising the steps of:
extracting data representing the enterprise from standard federal tax return information and a set of standard questions, all as input via the user interface
generating financial values representing the financial aspects of the enterprise from the extracted input data and from the financial values generated by the models,
including:
determining at the most detailed level available which industry the enterprise operates in,
determining an enterprise officer's compensation as an expense of the enterprise,
determining the discretionary expense levels consistent with maintaining the on-going operation of the business
determining an enterprise's revenue and profit growth in order to determine the enterprise's growth trajectory.
determining present and expected values of the enterprise as functions of present and expected profits and costs of the enterprise,
generating a control premium value wherein a control premium value represents an increase over a market value of a minority interest in the enterprise represented by ownership of the enterprise, and
generating from the financial values at least one valuation output representing a value of the enterprise.

13. The method of claim 12 for determining the value of the business enterprise, further comprising the step of:
generating a liquidity discount value representing a decrease in an ownership value of the enterprise due to an increased risk in selling the enterprise arising if the enterprise being valued is privately owned enterprise.

14. The method of claim 12 for determining the value of a business enterprise, further comprising the step of:
determining operating and non-operating incomes of the enterprise as separate values.

15. The method of claim 12 for determining the value of the business enterprise, wherein the step of determining present and expected values of the enterprise as functions of present and expected profits and costs of the enterprise further comprises:
determining an enterprise tax shield value that is independent of a method by which the enterprise assets are financed.

16. The method of claim 12 for determining the value of the business enterprise, wherein the step of determining present and expected values of the enterprise as functions of present and expected profits and costs of the enterprise further comprises:
determining present and expected operating profits of the enterprise.

17. The method of claim 12 for determining the value of the business enterprise, wherein the step of determining present and expected values of the enterprise as functions of present and expected profits and costs of the enterprise further comprises:
determining an expected growth in operating profits of the enterprise.

18. The method of claim 12 for determining the value of the business enterprise, wherein the step of determining present and expected values of the enterprise as functions of present and expected profits and costs of the enterprise further comprises:
determining enterprise cash flow over a competitive advantage period.

19. The method of claim 12 for determining the value of the privately owned business enterprise, wherein the step of determining present and expected values of the enterprise as functions of present and expected profits and costs of the enterprise further comprises:
determining an average cost of capital for the enterprise over a period of competitive advantage.

20. The method of claim 12 for determining the value of the business enterprise, wherein the step of extracting data representing the enterprise further includes the steps of presenting questions pertaining to the enterprise to a user through the user interface and extracting information from responses to the questions.
